(19) United States
(12) Patent Application Publication
(10) Pub. No.: US 2020/0269513 A1
(43) Pub. Date: Aug. 27, 2020

(54) THREE-DIMENSIONAL PRINTING MATERIAL VALIDATION

(71) Applicant: HEWLETT-PACKARD DEVELOPMENT COMPANY, L.P., Spring, TX (US)

(72) Inventors: Luis Garcia, Sant Cugat del Valles (ES); Natalia Garcia, Sant Cugat del Valles (ES); Alex Andrea, Sant Cugat del Valles (ES)

(21) Appl. No.: 16/608,856

(22) PCT Filed: Nov. 13, 2017
(86) PCT No.: PCT/US2017/061259

§ 371 Date: Oct. 27, 2019

(51) Int. Cl. B29C 64/393; B29C 64/336; B29C 64/255

(52) U.S. Cl. CPC B29C 64/393; B33Y 10/00; B29C 64/255; B29C 64/336

(57) ABSTRACT

Examples of the present disclosure relate to a three-dimensional printing preparation controller. The controller comprises a processor, a data storage coupled to the processor and an instruction set to cooperate with the processor and the data storage. The instruction set detects a request to mix a first and a second material in a specific proportion, the first and the second material having respectively first and second characteristics; the first characteristics differing from the second characteristics, validates the request by comparing the specific proportion and the first and second characteristics with validated proportions and validated characteristics and mixes the first and second materials in the specific proportion if the request is validated to correspond to validated proportions and validated characteristics.

### BACKGROUND

Additive manufacturing techniques, such as three-dimensional printing, relate to techniques for making three-dimensional objects from a digital three-dimensional model through an additive processes. In these processes, three-dimensional objects are generated on a layer-by-layer basis under computer control. A large variety of additive manufacturing technologies have been developed, differing in deposition techniques and processes by which the three-dimensional object is formed from a material.

### BRIEF DESCRIPTION OF THE DRAWINGS

Various example features will be apparent from the detailed description which follows, taken in conjunction with the accompanying drawings, wherein:

FIG. 1 is a block diagram of an example three-dimensional printing preparation controller according to the present disclosure.

FIG. 2 is a block diagram of another example three-dimensional printing preparation controller according to the present disclosure.

FIG. 3 is a block diagram of an example three-dimensional printing system according to the present disclosure.

FIG. 4A is a block diagram of an example three-dimensional printing system according to the present disclosure.

FIG. 4B is a block diagram of an example three-dimensional printing system according to the present disclosure.

FIG. 5 is a block diagram of an example method of printing a three-dimensional object according to the present disclosure.

### DETAILED DESCRIPTION

When forming an object using three-dimensional printing a material is used to build the object. This material has characteristics and depending on the object to be printed these characteristics may be more or less appropriate. For example, one could aim at obtaining an object which may have a specific tensile strength. The customization of an object to influence its properties can be obtained by using a specific material providing such properties. This could lead a manufacturing operation to store a significant number of different powdered, powder-like or granular build materials for use to build different objects. Such storage of materials could lead to significant costs, or even to loss of material (for example if a specific material is not used for a time and loses its properties over time). An alternative to the storage of a significant number of different materials is to use mixtures of materials as proposed in the present disclosure. Using a mixture of different materials can provide for a customization which would reduce the number of different material types which would be stored. For example, instead of storing a material comprising 10% by weight of glass beads and another material comprising 20% by weight of glass beads and yet another material comprising 30% by weight of glass beads, one could store separately the material without glass beads and the glass beads as separate components, and mix the 2 materials according to the desired customization. This possibility to use mixtures, while offering numerous design possibilities and reducing operating costs does however present risks. Risk include using a mixture which could either lead to unacceptable object or product properties, or even to damaging a three dimensional printer or one or more of its components, such as clogging of filters or melting of material at a temperature higher than desired. Such risks could be very costly for a manufacturing operation. In the present disclosure, the mixture is validated to maintain the advantage of customized manufacturing, while reducing storage of materials, and prevent such risks. The validation provided in this disclosure can also, in an example, allow warning of a user if the amount of first or second material is not sufficient for printing the object.

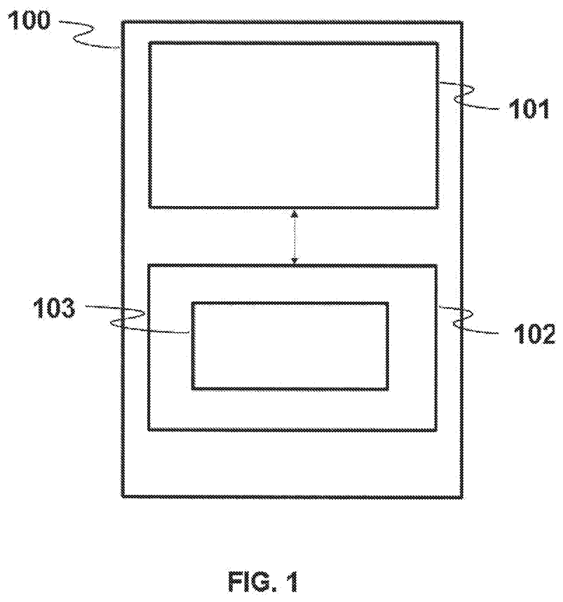

According to an example as shown in FIG. 1, three-dimensional objects can be generated using a three-dimensional printing preparation controller 100. The three-dimensional printing preparation controller 100 may be a controller dedicated to the preparation of a three-dimensional printing operation, or may be controlling other additional tasks, including other three-dimensional printing tasks such as the three-dimensional printing operation itself. In an example, the three-dimensional printing occurs using a dedicated three-dimensional printing preparation unit, the three-dimensional preparation unit being a processing station dedicated to the management of the first and second materials, comprising operations that may include one or more of: unpacking containers of the first and second materials; storage of the first and second materials; mixing of the first and second materials in a mixer to obtain a mixture of the first and second materials for printing; storage of the mixture of the first and second materials; filling of the three-dimensional printing system with the mixture of first and second material for printing; cooling of the mixture of first and second material following the printing operation; sieving of the material following the printing operation; and storage of a recycled mixture of first and second materials. In an example, the three-dimensional printing preparation controller also controls the quality, quantity and validity of a printing material or material mixture. In an example, the three dimensional printing preparation controller communicates the characteristics of the first and second material and of the mixture to a printing component so that the printing component can operate in accordance with the first and second material and proportion concerned, for example through setting elements of the printing process such as speed and temperature. In one example, the three dimensional printing preparation controller is part of a three dimensional printing system. In an example, the printing system is a complete printing system including a printing preparation station and a printer. In another example, the printing system is a partial printing system comprising a printing preparation station, the printer being separated from the printing separation station.

The controller 100 comprises a processor 101. The processor 101 performs operations on data. In an example, the processor is an application specific processor, for example a processor dedicated to three-dimensional printing preparation, or to three-dimensional printing. The processor may also be a central processing unit.

The controller 100 comprises a data storage 102. Data storage may include any electronic, magnetic, optical, or other physical storage device that stores executable instructions. Data storage 102 may be, for example, Random Access Memory (RAM), an Electrically-Erasable Programmable Read-Only Memory (EEPROM), a storage drive, an optical disk, and the like. Data storage 102 is coupled to the processor 101.

The controller 100 comprises an instruction set 103. Instruction set 103 cooperates with the processor 101 and the data storage 102. In the example, instruction set 103 comprises executable instructions for the processor 101, the executable instructions being encoded in data storage 102.

The instruction set 103 cooperates with the processor 101 and the data storage 102 to detect a request to mix a first and a second materials in a specific proportion. The detection of a request may take place through a human physical user interface, for example by way of a keyboard, mouse, display or touchscreen. The detection of a request may take place through a network interface connected to a network, the request being provided remotely. In an example, the request is selected by a user by selecting a material or mixture proposed by a print driver which could be executed on a host computer. Such a host computer could run a 3d model editing software, for example. In an example, the processor of this disclosure or another processor runs instructions which propose a first and second material as well as a proportion to a user in order to obtain a printed object as desired. In such an example, the first and second material as well as the proportions are selected on behalf of the user, therefore facilitating the choice of an appropriate mixture. The first and second material may be selected by a designer of the object. The first and second material may be specified in an object model file or in a print job or print job file.

The request is a request to mix a first and a second materials in a specific proportion. The proportion may be a proportion by weight. The proportion may be a proportion by volume. In an example, 20% of the volume of the mixture is a glass beads material in order to obtain a desired amount of abrasion resistance properties. The proportion may be a proportion by molecular weight. In an example, the first and the second material are build materials or materials for additive manufacturing used to form objects through additive manufacturing. The objects may be generated by solidifying portions of successive layers of the mixture of the first and second materials. Each of the first and second materials can be powder-based and the properties of generated objects may be dependent upon the type of material and the type of solidification. In some examples, solidification of the material is enabled using a liquid binding agent, such as an adhesive. In further examples, solidification may be enabled by temporary application of energy to the mixture of the first and second materials, for example using a focused laser beam. In certain examples, liquid fusing agents are applied to the mixture of the first and second materials, wherein a fusing agent is a material that, when a suitable amount of energy is applied to a combination of the mixture of the first and second materials and fusing agent, causes the material to heat up, to melt, fuse and solidify. Other agents may also be used, e.g. agents that inhibit or modify a level of fusing when selectively deposited in certain areas. In other examples, other materials and other methods of solidification may be used. In examples, the first, second or mixture of materials may be dry, or substantially dry, powder. The first, second or additional material are in an example materials which participate to forming the body of the object being manufacture in a significant manner. In an example, each of the first, second or additional material contribute to forming at least 1% by weight of the object. In an example, each of the first, second or additional material contribute to forming at least 2% by weight of the object. In an example, each of the first, second or additional material contribute to forming at least 1% by weight of the object. In an example, each of the first, second or additional material contribute to forming at least 5% by weight of the object.

In one example the first material, second material or mixture material, each taken independently or in a combination, is a powder that has an average volume-based cross-sectional particle diameter size of between approximately 5 and approximately 400 microns, between approximately 10 and approximately 200 microns, between approximately 15 and approximately 120 microns or between approximately 20 and approximately 70 microns. Other examples of suitable, average volume-based particle diameter ranges include approximately 5 to approximately 70 microns, or approximately 5 to approximately 35 microns. In an example a volume-based particle size is the size of a sphere that has the same volume as the powder particle. With “average” it is intended to explain that most of the volume-based particle sizes in a container are of the mentioned size or size range but that the container may also contain particles of diameters outside of the mentioned range. For example, the particle sizes may be chosen to facilitate distributing material layers having thicknesses of between approximately 10 and approximately 500 microns, or between approximately 10 and approximately 200 microns, or between approximately 15 and approximately 150 microns. One example of a three-dimensional printing system may be pre-set to distribute a mixture of the first and second materials layers of approximately 80 microns using containers that contain powder having average volume-based particle diameters of between approximately 40 and approximately 60 microns. For example, the three-dimensional printing system can be configured or controlled to form powder layers having different layer thicknesses.

Suitable powder-based materials for use as first or second material in this disclosure include one of polymers, crystalline plastics, semi-crystalline plastics, polyethylene (PE), polylactic acid (PLA), acrylonitrile butadiene styrene (ABS), amorphous plastics, polyvinyl alcohol plastic (PVA), polyamide, thermo(setting) plastics, resins, transparent powders, colored powders, metal powder, ceramics powder such as for example, glass particles, and/or a combination of at least two of these or other materials, wherein such combination may include different particles each of different materials, or different materials in a single compound particle. Examples of blended materials include alumide, which may include a blend of aluminum and polyamide, multi-color powder, and plastics/ceramics blends. Blended material may comprise two or more different respective average particle sizes.

In other examples, the first or second material comprises fibers. These fibers may for example be formed by cutting extruded fibers into short lengths. The length may be selected to allow effective spreading of the first or second material onto a build platform. For example, the length may be approximately equal to the diameter of the fibers.

In other examples, the first or second material comprises plastics, ceramic, or metal, independently or in combination, for example in powder, powder-like or granulated form.

A particular batch of the first or second material may be new (or fresh) material or used material. New material should be considered to be a material or build material which has not previously been used in the process of manufacturing an object. An unopened supply of material as supplied by a material manufacturer may therefore contain new material. By contrast, used material is material which has previously been supplied to a three-dimensional printing system for use in an additive manufacturing process but which has not been solidified during the process. For example, the used material may be produced during a thermal-fusing, three-dimensional printing operation, in which powder material is heated to close to its melting temperature for a period of time which may be sufficient to cause material degradation of the powder. In this respect, it will be understood that not all of the material supplied to a three-dimensional printing system for use in an additive manufacturing process may be used and/or incorporated into a three-dimensional printed article. At least some of the non-solidified material recovered during or after completion of a three dimensional print job may be suitable for reuse in a subsequent additive manufacturing process. Such material may be stored, for example internally or externally, to the three-dimensional printing system for subsequent use. The used material may be mixed with new material for subsequent printing routines. The mixing proportion may be variable, for example based on powder properties. In one example, a mix of 80% used and 20% new material may be used for prototyping, with 100% new material being used for certain objects. In another example, a mix of 80% used and 20% new powder is used for production parts, with a higher proportion of used powder being used for prototyping. Material containers may be used to supply recycled or reconditioned (i.e. used but unsolidified) material in addition to, or instead of, new (i.e. unused) material. In certain cases, material of varying qualities may be supplied, e.g. different material reservoirs may supply different grades of material that each adhere to different quality specifications. In some examples, used material is returned to a supplier of material. The supplier may then provide reconditioned used material, or a mixture of reconditioned used material and new material, at a lower cost than pure new material. Different grades of material may be adapted for different uses, e.g. recycled or reconditioned material may be used for prototyping, and material with a large proportion of new material (e.g. greater than 50-80%) may be used for production.

In an example, the printing system comprises a piezo printhead. In an example, the printing process takes place using a binding agent to glue a powder, powder-like or granulated mixture of the first and second materials. In an example, the printing system comprises a piezo printhead and comprises using a binding agent. In an example, the printing system comprises a piezo printhead, comprises using a binding agent, whereby one or more of the first, second or additional materials comprises a color pigment. In an example, the printing system comprises a piezo printhead, comprises using a binding agent, whereby one or more of the first, second or additional materials comprises a metal.

The first and the second material have respectively first and second characteristics, the first characteristics differing from the second characteristics. An example of a characteristic is a chemical composition. For example, the first material may be a polyamide, and the second material may be glass particles. In an example, a first material having a specific granularity or average particle size is mixed with a second material having low friction properties in order to obtain a combination allowing improvement of the spreading properties or characteristics of the first material when forming particle layers for printing. Another example of a characteristic is a granularity. For example, the first material may have an average volume-based cross-sectional particle diameter size of 50 microns, and the second material may have an average volume-based cross-sectional particle diameter size of 25 microns. In another example, the first material has a first color and the second material has a second color different from the first, whereby the use of a range different proportions can produce a range of colors between the two of the colors. Such color variation could be applied to additional materials beyond the first and second material to access a wide gamut of colors for the mixture, for example by using a first material with cyan color, a second material with magenta color, an additional third material with a yellow color and an another additional material with a black color, each of these four materials being validated or having validated characteristics, and mixing them to form a mixture in proportions validated according to this disclosure.

Mixing a first and second material having different characteristics permits the making of objects having a broad range of properties while having access to a limited gamut of materials. The present disclosure allows an expansion of the number of materials used for three-dimensional printing. For example, the first material may be a Polyamide 12 (PA12) or Nylon 12 with the formula [(CH₂)₁₁C(O)NH]ₙ while the second material may comprise glass beads to increase abrasion or resistance of the object compared to using PA12 on its own. For example, the first material may be a Polyamide 12 (PA12) or Nylon 12 with the formula [(CH₂)₁₁C(O)NH]ₙ while the second material may comprise a fire retardant to increase fire resistance properties of the object compared to using PA12 on its own. For example, the first material may be a Polyamide 12 (PA12) or Nylon 12 with the formula [(CH₂)₁₁C(O)NH]ₙ while the second material may comprise glass fibers which could lower deformation of the object when compared to using PA12 on its own. For example, the first material may be a Polyamide 12 (PA12) or Nylon 12 with the formula [(CH₂)₁₁C(O)NH]ₙ while the second material may comprise coloring material to produce a colored object compared to using PA12 on its own. PA11 (polyamide 11 or nylon 11) can also be used instead of PA12. A mixture according to the present disclosure allows optimizing the mixture to enable specific object properties of the resulting object, enabling specific final applications. This flexibility is obtained without compromising the logistics of a three-dimensional printing operation by allowing to obtain a vast number of mixtures based on a limited gamut of base materials.

The instruction set 103 cooperates with the processor 101 and the data storage 102 to validate the request by comparing the specific proportion and the first and second characteristics with validated proportions and validated characteristics. In an example, validated proportions and validated characteristics are produced by a material provider, a community of users, a provider of three-dimensional printers, universities or learning dusters. In an example, such validated proportions and characteristics are defined after due testing of combinations of materials, ensuring that such combinations lead to obtaining objects having acceptable characteristics, avoid damage to the three dimensional printer or to one or more of its components, or ensuring that the first and second materials are compatible. Compatibility could for example be chemical compatibility to avoid undesired chemical reactions, materials incompatibilities such as materials not compatible with fluid agents, or a print process, or mechanical incompatibilities such as materials not forming layers in an appropriate manner or not being processable through a transport system of the printing system. In an example, the validated proportions are corresponding to specific validated characteristics, such as “X % by weight of material with characteristic U and (100−X) % of material with characteristic V” where U is a chemical composition, V is another chemical composition, and X a number between 0 and 100. In another example, the validated proportions are corresponding to a range of validated characteristic, such as “X % by weight of any of materials of characteristics U, V or T and (100−X) % by weight of any of materials with characteristics A, B, C or D, where T, A, B, C and D are for example a chemical composition. In an example, the validated proportions are specific proportions such as “10% by weight” or “20% by volume”, in which case the comparison would take place by matching the specific proportion with one of the validated proportions. In another example, the validated proportions are “between Y1% and Y2% by weight”, where Y1>Y2 and Y1 and Y2 each are numbers between 0 and 100 or between 20 and 80, or between 30 and 70, or between 40 and 60, the comparison taking place by placing the specific proportion within or outside the valid range, meaning between Y1 and Y2. In another example, validated proportions are defined by a threshold such as “less than W1% by weight” or “less than V1% by volume”, in which case the comparison would take place by placing the specific proportion above or below the valid threshold, each W1 and V1 being between 0 and 100, or between 20 and 80, or between 30 and 70, or between 40 and 60. In an example, validated characteristics are by granularity or by chemical composition, or by commercial name of a product. In an example, the specific proportion is defined by net weight of respectively the first and second material.

The instruction set 103 cooperates with the processor 101 and the data storage 102 to mix the first and second materials in the specific proportion if the request is validated to correspond to validated proportions and validated characteristics. If the first and second materials have characteristics which correspond to validated characteristics but have a proportion which does not correspond to a validated proportion, the mix will not take place. This could be to protect the three-dimensional printing system from damage, to avoid manufacture of faulty objects, or due to the fact that a specific mix has not been considered for validation even though it may be appropriate. In an example, one could propose submitting a new mixture defined by a set of characteristics and proportions for validation if it is not validated already.

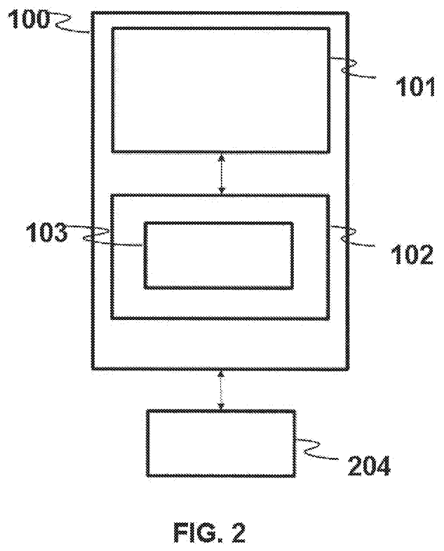

In an example illustrated in FIG. 2, the instruction set 103 cooperates with the processor 101 and the data storage 102 to access a database 204, the database comprising the validated proportions and validated characteristics. Such validated proportions and characteristics may be defined by validation conditions including valid ranges, valid thresholds, or being included on a list of valid entries or levels. The database may be stored remotely (as illustrated), or may be stored locally. In one example, the database is stored on storage 103. In the example of FIG. 2, the database is remote and is accessible via a networking connection. The database may be a public or a private database. The database may be provided by a material provider, by a manufacturer of three-dimensional printing systems or by a group of users for example.

A database 204 could for example hold information as illustrated below:

| | Validated | | |
|---|---|---|---|
| | Proportion | | |
| | Range by | | |
| | weight of the | Properties | |
| | second material | gained by | |
| | compared to the | using the | Risk of using |
| First and | weight of the | validated | non validated |
| Second Material | mixture | mixture | proportions |
| PA11 or PA12 | up to 50% by | A higher | Excess of |
| as first material | weight of | proportion | glass beads |
| and glass beads | glass beads | of glass | would lead to |
| as second material | | beads leads | poor tensile |
| | | to increased | strength and |
| | | abrasion | elongation |
| | | properties | |
| Polypropylene | up to 40% by | A higher | Excess of |
| as first material | weight of | proportion | Hydrous |
| and Hydrous | Hydrous | of Talc | Magnesium |
| Magnesium | Magnesium | increases | Silicate would |
| Silicate as | Silicate | flame | lead to poor |
| second material | (Talc) | retardant | mechanical |
| | | properties | properties. |
| Polyoxymethylene | up to 25% by | Addition | Excess of |
| as fist material | weight of | of TPU | TPU could |
| and thermoplastic | thermoplastic | increases | lead to poor |
| polyurethane as | polyurethane | interlayer | mechanical |
| second material | | adhesion | properties. |
| (TPU) | | | |
| PA11 as first | up to 30% by | A higher | Excess of |
| material and | weight of | proportion | PFTE could |
| Polytetraflu- | Polytetraflu- | of PFTE | lead to poor |
| oroethylene | oroethylene | increases | mechanical |
| (PFTE) as | | flow ability | properties. |
| second material | | of the | |
| | | mixture | |
| First material | up to 40% by | A higher | Excess of |
| (PA11 or PA12 | weight of | proportion | carbon black |
| or other) and | carbon black | of carbon | would lead to |
| carbon black as | | black | poor selectivity |
| second material | | increases | between printed |
| | | conductivity | and unprinted |
| | | | area |
| First material | Up to 3% by | A higher | Excess of |
| (PA11 or PA12 | weight of | proportion | color pigment |
| or other) and | color pigmeat | of color | would lead to |
| color pigment | | pigment | poor selectivity |
| | | leads to | between printed |
| | | more | and unprinted |
| | | colorful | area |
| | | objects | |

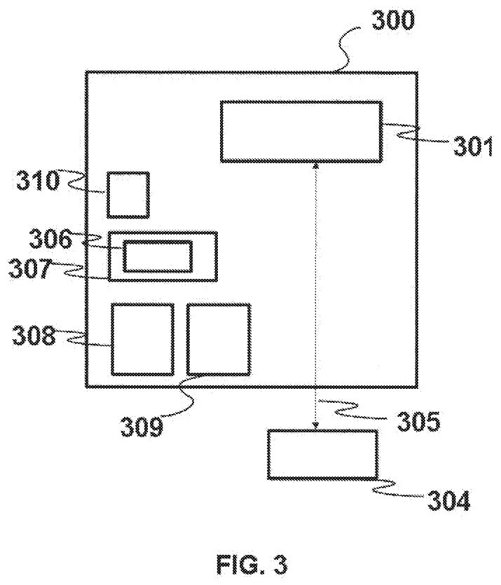

In FIG. 3 a three-dimensional printing system 300 according to the present disclosure is represented. The three-dimensional printing system 300 comprises a processor 301, the processor to collect characteristics of a first and a second material, the first material being different from the second material. In an example, the first material differs from the second material in that it has different characteristics, such as a different chemical composition.

The processor 301 accesses a database 304 of validated mixtures of materials. In this example, the database is stored remotely, and may be accessible via a networking connection 305.

The processor 301 checks that the specific mixture corresponds to one of the validated mixtures. In an example, the check is done by checking that the first material is included in the database as a validated material with validated characteristics, and the second material is included in the database as a validated material with validated characteristics, and the mixture of this first and second materials in the specific proportions is also validated in such proportions in the database. 304 of validated mixtures of materials.

The processor 301 operates the printing system 300 if the specific mixture corresponds to one of the validated mixtures. In this example, if the specific mixture does not correspond to a validated mixture, the processor will not operate the printing system to avoid one or more potential issues or risks as listed above. In an example, operating the printing system comprises mixing the first and second materials to obtain the validated mixture.

The three-dimensional printing system 300 comprises a scale 306, wherein a controller controls the preparation of the specific mixture using a weight proportion determined by the scale.

In an example, the first material is deposited on the scale from a hopper or transport system until a specific weight is detected. When the specific weight is detected the deposition of the first material is stopped, for example by closing a supply valve on the hopper or transport system. The second material is thereafter deposited on the scale, either from the same hopper or from a different supplying mechanism as the first material to complete the mixture as desired. If the same supply mechanism is used for both the first and second materials, a user may have to empty and clean the supply mechanism. In an example, two or more supply mechanisms are provided to deposit the respective material on the scale for weighing.

The three-dimensional printing system 300 comprises a mixer 307. In this example, the scale is comprised in the mixer. Including the scale in the mixer permits depositing the first and second materials in the mixer while weighing the materials, obtaining a compact design of the three-dimensional printing system. In another example, the printing system comprises a mixer and a scale, the scale being located outside of the mixer. One should note that comprising a mixer in the three-dimensional system according to an example facilitates mixing which would otherwise take place with dedicated equipment away from the three dimensional printing system, adding complexity to the overall process and operations. A mixer can provide for a homogeneous mixture by mixing the first and second material appropriately. In an example, the mixer has a volume smaller than the total volume of material desired to build the object. In such a case, several batches of material may be successively mixed in the mixer.

The three-dimensional printing system 300 comprises a first reservoir 308 and a second reservoir 309. The first reservoir 308 is for containing the first material and the second reservoir 309 is for containing the second material. The system of the disclosure could also function with a single reservoir, using the single reservoir for the first and the second material, for example one after the other. In an example, each of the first and second reservoirs is connected to a respective first and second supply mechanisms or transport systems for depositing the first and second materials on the scale 306.

Three-dimensional printing system 300 comprises a chip reader 310, the characteristics of one or more of the first, second and additional materials are being collected by reading a chip. In an example, the first and the second material are provided in dedicated containers, the dedicated containers being placed in the three-dimensional printing system, the dedicated containers comprising a chip, each chip being in contact with the chip reader when the container is placed in the three-dimensional printing system, each chip holding information related the characteristics of the first and respectively second material. Such material containers may be placed alternatively in the three-dimensional printing system, for example if the three-dimensional printing system is provided with a single chip reader, or may be placed in respective locations in the three-dimensional printing system with respective chips and respective chip readers. In an example, the chip is an RFID (Radio Frequency Identification) chip. In an example the chip reader and the chip are not in contact. In another example, the characteristics of the specific mixture are collected using a user interface such as a keyboard or a touch screen instead of using a chip reader. In an example, the characteristics of the first and second materials are collected by reading a chip, and the specific proportion of the mixture is collected using a user interface comprised in the three-dimensional printing system. In another example, the characteristics of the first and second materials and the specific proportion are collected electronically from a remote source using a connection to a network instead of using a chip reader.

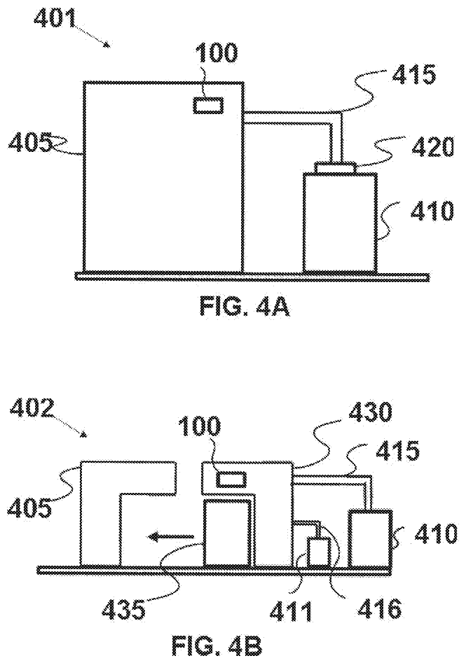

FIGS. 4A and 48 show example three-dimensional printing systems according to the present disclosure.

FIG. 4A shows a three-dimensional printing system 401 comprising a three-dimensional printer 405, a material container 410, and a material transport system 415 for transporting material between the material container 410 and the three-dimensional printer 405. The three-dimensional printing system 401 may be an additive manufacturing system for generating three-dimensional objects using material stored in the material container 410. The three-dimensional printer 405 may comprise a three-dimensional printing part and a separate material management part. Alternatively, the three-dimensional printer 405 may comprise a three-dimensional printing module and a material management module incorporated within a single apparatus. The transport system 415 may comprise an aspiration system (not shown), which generates suction, vacuum, or pressure to extract material from the material container 410 for delivery to the three-dimensional printer 405 by pneumatic transport. The transport system 415 may include an Archimedes screw. Connection between the transport system 415 and the material container 410 is facilitated by a material outlet structure 420. The material container 410 may also provide an aspiration channel through which material stored in the container 410 may be extracted or “aspirated” via the transport system 415 to the three-dimensional printer 405. According to some examples, the transport system 415 is provided with a nozzle structure (not shown) to connect to the outlet structure 420 of the container 410 in a sealable manner (e.g. a gas/fluid seal), thereby facilitating pneumatic transport of the material from the material container 410 to the three-dimensional printer 405. Controller 100 of FIG. 1 is integrated in printer 405. First material and second material may be successively placed in container 410 to be transported by 415 to prepare the mixture.

FIG. 4B shows one example of a three-dimensional printing system 402 that comprises a three-dimensional printer 405 and a separate material management station 430 (sometimes referred to as a “processing station”). If the material management station 430 is arranged to supply the three-dimensional printer 405 with material it may be referred to as a “supply system”. In FIG. 4B, the material management station 430 comprises the transport system 415 to extract a first material from a first material container 410 and a second transport system 416 to extract a second material from a second material container 411. In certain cases, the material management station 430 may be arranged, additionally or alternatively, to fill, or transfer material to, the material container 410 or 411 via an inlet structure using the transport system 415 or 416. In FIG. 4B, a unit 435 such as a moveable trolley is filled with the mixture of the first and the second material by the material management station 430 and then is moved to the three-dimensional printer 405 for the printing of an object. For example, the unit 435 may be coupled to both the material management station 430 and the three-dimensional printer 405. In other examples, the build unit 435 may be fixed or have a constrained movement path, for example comprising a moveable carriage. Although the three-dimensional printing system 402 is shown as having separate units in FIG. 48, in certain implementations these may form separate sections of a single apparatus. The material management station 430 may manage first and second materials extracted from material containers 410 and 411 in order to form the mixture to fill the unit 435 with the mixture of the first and second materials for use in a subsequent three-dimensional printing operation. In certain cases, the unit 435 may be returnable to the material management station 430 following printing. For example, the material management station 430 may be used to remove non-solidified material following completion of a printing operation. Non-solidified material may be used as recycled material for future printing, for example used to fill the unit 435 for future objects to be built. Material management station 430 comprises the three-dimensional printing preparation controller 100 of FIG. 1.

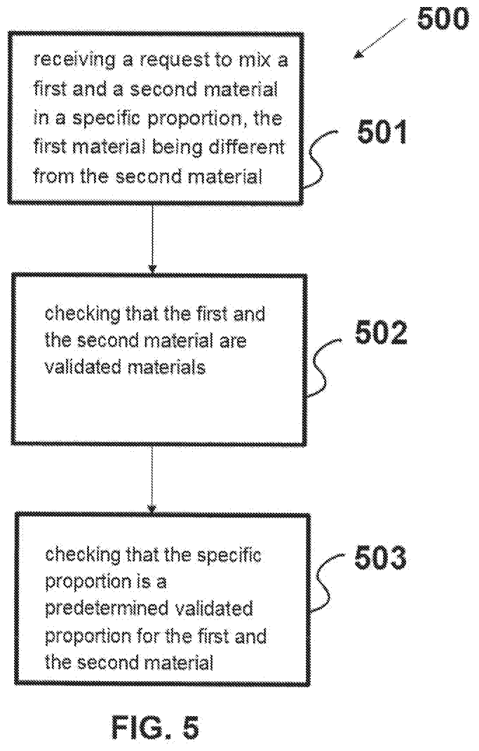

FIG. 5 illustrates an example method 500 of printing a three dimensional object comprising receiving (501) a request to mix a first and a second material in a specific proportion, the first material being different from the second material. In various examples, the request may be received by a user through a human user interface, for example including a keyboard, mouse or touchscreen, or be received electronically through a network, or by collected information from a chip, for example a chip placed on a material container, or from a combination of such sources.

Example method 500 comprises checking (502) that the first and the second material are validated materials, or included in a predetermined list of validated materials for example. In an example the predetermined list of validated materials is available locally in a database encoded on a storage medium comprised in a controller of the three-dimensional printing system such as controller 100 of FIG. 1. In another example the predetermined list of validated materials is available remotely via a networking connection, the three-dimensional printing system being connected to a network. In an example the list is predetermined in that a number of materials have been previously validated as suitable for use in a mixture of materials to produce three dimensional objects using the three-dimensional printing system.

Example method 500 comprises checking (503) that the specific proportion is a predetermined validated proportion for the first and the second material. In an example, each mixture of specific validated materials is associated with validated proportions for the mixtures. The validated proportions may for example be available as a list or a set of proportions. The validated proportions may be available as ranges. The validated proportions may be limited by a threshold. The validated proportions may be defined by a combination of any of a list, one or more ranges or one or more thresholds.

In an example, method 500 comprises printing the object using a mixture of the first and second materials in the specific proportion if the first and second materials are validated materials and if the specific proportion is a predetermined validated proportion for the first and the second material. Proceeding in this manner may avoid using mixtures which could result in printing an object of undesirable quality, or using mixtures which could damage a printing system, or using mixtures which have not been validated or tested. Such a printing process may take place in a component of the printing system separate from a material management station or such a printing process may take place in an integral system including a printer component and a material management component.

In example method 500, the first material comprises polyamide, polypropylene or polyurethane or polyoxymethylene or a mixture of these. In an example, the first material has a proportion of more than 50% by weight of the mixture. In another example, the first material has a proportion of more than 60% by weight of the mixture. In another example, the first material has a proportion of more than 70% by weight of the mixture. In another example, the first material has a proportion of more than 80% by weight of the mixture. In another example, the first material has a proportion of more than 90% by weight of the mixture. In another example, the first material has a proportion of more than 95% by weight of the mixture.

In example method 500, the second material comprises glass beads, glass fibers, carbon or carbon black particles, talc (Hydrous Magnesium Silicate), or polytetrafluoroethylene, fire retardant agents or color pigments. In an example, the second material has a proportion of less than 50% by weight of the mixture. In another example, the second material has a proportion of less than 40% by weight of the mixture. In another example, the second material has a proportion of less than 30% by weight of the mixture. In another example, the second material has a proportion of less than 20% by weight of the mixture. In another example, the second material has a proportion of less than 10% by weight of the mixture. In another example, the second material has a proportion of less than 5% by weight of the mixture.

In an example, the printing process is adapted to a first and second material and proportion combination. For example, if the second material comprises carbon or carbon black, the mixture will collect more heat than it would without carbon or carbon black due to a change in absorption selectivity. A higher proportion of a material leading to higher levels of carbon or carbon black could imply lowering the heating of a print bed to lower the energy leading to the fusion of the mixture.

In an example method, the first and second materials are in powder form. In an example method, the first and the second material are loaded and weighted according to the specific proportion in a mixer prior to being mixed. The mixer may be comprised in the three-dimensional printing system. The mixer may comprise a scale to measure the weight of the first and second materials to obtain the specific proportion of the mixture.

The method may comprise identifying in the request one or more additional materials, each additional material being different from any of the first, second or other additional materials; checking that the one or more additional materials are validated materials, checking that the specific proportions of the one or more additional materials are predetermined validated proportions; and print the object using the mix if the one or more additional materials are validated materials and if the specific proportion is a predetermined validated proportion. This permits obtaining mixtures using more than 2 different materials which in turn provide for additional customized and validated mixture possibilities.

The preceding description has been presented to illustrate and describe certain examples. Different sets of examples have been described; these may be applied individually or in combination, sometimes with a synergetic effect. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. A three-dimensional printing preparation controller, the controller comprising:
a processor;
a data storage coupled to the processor;
an instruction set to cooperate with the processor and the data storage to:
detect a request to mix a first and a second material in a specific proportion, the first and the second material having respectively first and second characteristics; the first characteristics differing from the second characteristics;
validate the request by comparing the specific proportion and the first and second characteristics with validated proportions and validated characteristics;
mix the first and second materials in the specific proportion if the request is validated to correspond to validated proportions and validated characteristics.

2. A three-dimensional printing preparation controller according to claim 1, whereby the instruction set accesses a database, the database comprising the validated proportions and validated characteristics.

3. A three-dimensional printing preparation controller according to claim 1, whereby the first, second and validated characteristics include a chemical composition.

4. A three-dimensional printing preparation controller according to claim 1, whereby the first, second and validated characteristics include a granularity.

5. A three-dimensional printing system comprising a processor to:
collect characteristics of a specific mixture of a first and a second materials, the first material being different from the second material;
access a database of validated mixtures of materials;
check that the specific mixture corresponds to one of the validated mixtures;
operate the printing system if the specific mixture corresponds to one of the validated mixtures.

6. A three-dimensional printing system according to claim 5, whereby the printing system comprises a scale, and wherein a controller controls the preparation of the specific mixture using a weight proportion determined by the scale.

7. A three-dimensional printing system according to claim 6, whereby the printing system comprises a mixer, whereby the scale is comprised in the mixer.

8. A three-dimensional printing system according to claim 5, whereby the printing system comprises a first and a second reservoir, the first reservoir for containing the first material and the second reservoir for containing the second material.

9. A three-dimensional printing system according to claim 5, whereby the printing system comprises a chip reader, whereby characteristics of first and second materials are collected by reading a chip.

10. A method of printing a three-dimensional object, comprising:
receiving a request to mix a first and a second material in a specific proportion, the first material being different from the second material;
checking that the first and the second material are validated materials;
and
checking that the specific proportion is a predetermined validated proportion for the first and the second material.

11. The method of printing according to claim 10, comprising printing the object using a mixture of the first and second materials in the specific proportion if the first and second materials are validated materials and if the specific proportion is a predetermined validated proportion for the first and the second material.

12. A method of printing according to claim 10, whereby the first material comprises polyamide, polypropylene, polyurethane or polyoxymethylene.

13. A method of printing according to claim 10, whereby the second material comprises glass beads, glass fibers, carbon particles, hydrous magnesium silicate, polytetrafluoroethylene, fire retardant agents or color pigments.

14. A method of printing according to claim 10, whereby the first and second materials are loaded and weighted according to the specific proportion in a mixer prior to being mixed.

15. A method according to claim 11, comprising:
identifying in the request one or more additional materials, each additional material being different from any of the first, second or other additional materials;
checking that the one or more additional materials are validated materials,
checking that the specific proportions of the one or more additional materials are predetermined validated proportions;
print the object using the mix if the one or more additional materials are validated materials and if the specific proportion is a predetermined validated proportion.
